(19) United States
(12) Patent Application Publication
(10) Pub. No.: US 2018/0357645 A1
(43) Pub. Date: Dec. 13, 2018

(54) VOICE ACTIVATED PAYMENT

(71) Applicant: Walmart Apollo, LLC, Bentonville, AR (US)

(72) Inventors: Stephen Tyler Caution, Bentonville, AR (US); Yurgis Mauro Bacallao, Centerton, AR (US); Michael Dean Atchley, Springdale, AR (US)

(21) Appl. No.: 15/987,979

(22) Filed: May 24, 2018

Related U.S. Application Data
(60) Provisional application No. 62/517,509, filed on Jun. 9, 2017.

(51) Int. Cl. G06Q 20/40; G10L 15/22; G06Q 20/10; G10L 15/26

(52) U.S. Cl. CPC G06Q 20/40145; G10L 15/265; G06Q 20/102; G10L 15/22

(57) ABSTRACT

A voice-actuated system is described that allows voice authentication of on-line secure commands, such as purchases, by one or more designated users. It allows for an account to have multiple signatories that are required to approve a secure command. A user speaks commands into a local microphone, or in another embodiment, into a mobile device. A command recognition device identifies a secure command and sends it to a spectrum/cadence device to analyze spectrum and/or cadence. Also, the voice input may be sent to a word count/grammar device to analyze word counts and grammar errors to identify the user. Once identified, the account of user may be found and contact information for other signatories is acquired. The signatories are contacted and their identities are verified by comparison of their voices to pre-stored voice samples of the signatories.

### RELATED APPLICATIONS

This application claims the benefit of U.S. Provisional Patent Application No. 62/517,509, filed Jun. 9, 2017 and entitled “Voice Activated Payment,” the contents of which are incorporated herein in their entirety.

### FIELD

The current invention relates to a system for authorizing on-line payments using voice authentication and more specifically to a system for authorizing on-line payments using voice authentication of more than one person.

### BACKGROUND

On-line purchases of goods and services (e-commerce transactions) are very popular and becoming increasingly more popular. On-line shoppers connect to an e-commerce site, navigate through webpages, browse and search to find a product to purchase. On-line purchasing typically involves several steps to verify the identity of the shopper, and authenticate the shopper to prevent unauthorized purchases and fraudulent activities.

An increasing percentage of on-line shoppers are now using smart phones, as compared with more traditional desktop computers, to purchase products. It is usually easier to speak to the smartphone to provide voice commands than typing on the tiny keyboards on smartphones. Therefore, there is an increasing need for servers and websites to support voice commands.

There is also a significant problem of fraud with on-line purchases. Biometric devices, such as fingerprint readers, help reduce this fraud. However, not all computing devices have the same biometric devices.

Currently, there is a need for more secure systems for purchasing products on-line (and for other secure transactions) that does not involve significant additional work on the part of the users.

### BRIEF SUMMARY

According to aspects of the present inventive concepts there is provided an apparatus and method as set forth in the appended claims. Other features of the inventive concepts will be apparent from the dependent claims, and the description which follows.

The claimed invention may be described as a voice actuated system 1000 adapted to provide secure authorization of secure commands. A microphone 101 is adapted to receive a local or first voice input from a local or first user 1. A mobile device 400 is adapted to communicate a remote or second voice input from a remote or second user 2, and a sound processing unit 100. The sound processing unit 100 has a communication device 521 adapted to communicate with the mobile device 400 and receive the remote voice input from the remote user 2. A sound command database 113 has prestored voice input to word data, prestored indications of commands and an indication of which commands are secure commands. Sound command database 113 also has prestored reference samples of secure commands from a plurality of users that can authorize secure commands. A speech recognition device 105 coupled to the communication device 521, the microphone 101 and the sound command database 113 is adapted to receive the remote voice input from the mobile device 400, the local voice input from the microphone 101 and match them to prestored voice inputs in the sound command database 113 to identify corresponding words. The sound processing unit 100 also includes a command recognition device 107 coupled to the speech recognition device 105 and the sound command database 113 adapted to receive the corresponding words and identify corresponding commands in the sound command database 113, and to identify commands that are secure commands. The sound processing unit 100 includes a voice authentication device 110 having a spectrum/cadence analyzer 108 that is coupled to the command recognition device 107 and the communication device 521. The voice authentication device 110 is adapted to receive the voice input and compare it to the prestored reference samples of secure commands from a plurality of authorized users in the sound command database 113 to determine a confidence level of how closely they match.

For verification of remote user 2, in addition to the above authentication, a location verification device 119 receives a location of the mobile device 400 and determine a confidence level of how closely this location matches locations where the mobile device 400 has previously been. A hardware verification device 121 is adapted to receive a hardware identification of the mobile device 400 and determine a confidence level of how closely it matches the hardware identification of mobile devices previously used by the remote user 2.

The sound processor 100 also includes a controller 111 coupled to the communication device 521 and the voice authentication device 110 that is adapted to use the determinations of the voice authentication device 110 for local users to determine if the confidence level exceeds a predetermined threshold to identify the local user 1.

The controller 111 is also coupled to the location verification device 119, and the hardware verification device 121 and is adapted to use the determinations of the voice authentication device 110 for local users, the location verification device 119, the hardware verification device, to determine if the combination exceeds a predetermined threshold to identify the remote user. If both the local user 1 and remote user 2 are properly identified and authorize the secure command, it is executed.

The current invention may also be embodied as a method of having a first user 1 and a second user 2 authorize execution of a secure command, by receiving a first voice input from a first mobile device 400-1 used by the first user 1, identifying the first user 1 at a sound processing unit 200 by finding a match for the first voice input in a sound command database 113, finding accounts associated with the first user 1, interacting with the first user 1 to select one of the accounts, finding contact information for a second mobile device 400-2 of a second user 2 required to authorize secure commands on the selected account, and sending a request for voice authorization to the second mobile device 400-2.

The process continues by receiving second voice input from the second mobile device 400-2, determining a level of confidence of how closely the voice input from the second mobile device 400-2 matches prestored voice for the second user 2, determining a level of confidence of how close the current location of the second mobile device 400-2 is to previous stored locations of the second user 2, determining a level of confidence of how closely the hardware identification of the second mobile device 400-2 matches a previously-stored hardware identification of a mobile device 400-2 used by the second user 2, combining the determined confidence levels of the voice authentication device 110, the location verification device 119, the hardware verification device 121, determining if the combination exceeds a predetermined threshold to identify the first user 1, and repeating the above steps for at least one additional user 2 before allowing execution of a secure command.

The current invention may also be embodied as a voice actuated system 2000 adapted to provide secure authorization of secure commands having a first mobile device 400-1 adapted to communicate a first voice input from a first user 1, a second mobile device 400-2 adapted to communicate a second voice input from a second user 2 and a sound processing unit 200.

The sound processing unit 200 includes a communication device 521 adapted to communicate with the mobile devices 400-1, 400-2 and receive the first voice input from first user 1 and second voice input from user 2. A sound command database 113 has prestored voice input associated with word data, and prestored indication of commands. It also has an identification of which commands are secure commands. The sound command database 113 has prestored reference samples of secure commands from a plurality of authorized users. A speech recognition device 105 is coupled to the communication device 521 and the sound command database 113 and is adapted to receive the first voice input and second voice input and match them to voice input in the sound command database 113 to identify corresponding words. A command recognition device 107 coupled to the speech recognition device 105 and the sound command database 113 is adapted to receive the words and identify corresponding commands in the sound command database 113. The command recognition device 107 is also adapted to identify if the commands are secure commands. The sound processing unit 200 also includes a voice authentication device 110 having a spectrum/cadence analyzer 108 coupled to the command recognition device 107 and the communication device 521. Voice authentication device 110 is adapted to receive the first voice input and the second voice input and compare them to the prestored reference samples of secure commands from a plurality of authorized users in the sound command database 113 to determine a confidence level of how closely they match. A location verification device 119 receives a location of the mobile device 400 and determines a confidence level of how close this location matches locations where the mobile device 400 has previously been located. A hardware verification device 121 is adapted to receive a hardware identification of the mobile device 400 and determine a confidence level of how closely it matches hardware identification of mobile devices previously used by the first user 1.

The sound processing unit 200 also includes a controller 111 coupled to the communication device 521 and to the voice authentication device 110, the location verification device 119, the hardware verification device 121, adapted to combine the determinations of the voice authentication device 110, the location verification device 119, the hardware verification device 121 to determine if the combination exceeds a predetermined threshold to identify the first user 1, and repeat the above steps for at least one additional user 2 before allowing execution of a secure command.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates a block diagram of a voice-actuated system allowing for voice authentication of secure commands according to one embodiment of the current invention.

FIG. 2 is a flowchart illustrating the functioning of a voice-actuated system according to one embodiment of the current invention.

FIG. 3 is a more detailed illustration of a step of the flowchart of FIG. 2.

FIG. 4 illustrates a block diagram of a voice-actuated system allowing for voice authentication of secure commands according to another embodiment of the current invention.

### DETAILED DESCRIPTION

a) Theory

Sound, including voice, is at every instant a mixture of many frequencies each having a specific amplitude and phase. This is perceived by the human ear as tones with overtones. If the sound is constant, like a constant note of an organ, it will have a spectrum with a characteristic shape. As the note played by the organ moves up or down, the spectrum will move up or down, but still maintain the characteristic shape. This characteristic shape allows us to differentiate between a trumpet and an organ playing the same note.

The same fundamentals apply to human voices. Humans have an innate nature to spectrum analyze spectral shapes ‘on the fly’. We are able to differentiate between two people that are saying the same sound by recognizing and comparing the characteristic shape of the spectrum.

Throughout this document, we will be referring to ‘speech recognition’ and ‘speaker authentication’ or ‘voice authentication’. Speech recognition is the recognition of sounds received as words or commands. Speaker authentication/voice authentication is the determination that a speaker is a specific person.

### Requires More Detailed Spectrum for Authentication

It requires a more detailed spectrum for speaker authentication as compared to speech recognition. As the spectrum includes more frequencies, the ability to differentiate between speakers increases. Therefore, one may determine a speaker to a specific level of confidence is related to the width of the spectrum analyzed.

Therefore, speech recognition requires less computation as compared with speaker authentication; however, it cannot differentiate between speakers.

### Speech Recognition

The system of the current invention will allow a shopper using the system (a “user”), to input voice commands to the system by saying words which have been associated with commands that the system will recognize.

Since speech is sound which change amplitude and frequency over time, it is possible to recognize elements of speech by generally matching time-changing sounds with pre-stored time-changing sounds, associated with elements of speech. Since speech recognition is usually done in real time, the amount of computations must be reduced to allow the processor to decode speech at the rate of an average speaker. It is computationally intensive to analyze sounds and to determine the amplitudes and phases for many frequencies and repeat this continuously for time-changing sounds, such as speech. This may be done by reducing the bandwidth of the frequency spectrum or sampling of the voice commands being analyzed.

### Reduced Spectrum/Sampling

It is possible to approximate a spectrum of a sound into a smaller spectrum of a single frequency having an amplitude and phase. This reduced spectrum is less computationally burdensome to process. This reduced spectrum analysis is accurate enough to allow recognition of speech, but not accurate enough to determine the person saying the speech (authenticate the speaker).

Since the frequency spectrum is continuous, it is sampled to result in digital samples. The finer the sampling, the more data there is to process and the slower the signal processing becomes. Therefore, one may adjust the coarseness of the sampling to allow for processing which can keep up with the speed of the speech being processed.

### Authentication Set-up

During a set-up phase, the user will read secure commands into the system. This will be stored as voice samples of specific secure commands for this user. The pre-stored samples will later be compared to voice input to authenticate the user.

### Detecting Emotions

The speech of a user changes when the speaker's emotions change. For example, when a speaker is angry, their speech changes. There are time-changing aspects of the amplitude and phase of various frequencies which signify attitude of a speaker. This is the case when a speaker is upset. The speed of the user's speech is referred to as the cadence. Typically, the cadence of the user's speech increases as they get more upset.

Therefore, if a user is providing voice commands to the system, the system may look for these changes in the speaker's voice to determine if the speaker is becoming upset. Once this is determined, there are a variety of actions the system may take.

There are on-line accounts which require more than one user to authorize purchases and other actions. Some of these require the consent of a second user, referred to as a “signatory”. One such type of account is one that allows a child to make purchases with the consent of the parent, the signatory.

Other types of accounts may be business accounts in which an employee of the company is required to have an officer of the company approve purchases above a specified dollar amount. In this case, the officer is the signatory.

In still other types of accounts, there may be more than one signatory that is required for certain actions. For example, it may require at least three officers to be signatories for purchases above a specified amount.

There are also other accounts which require one or more signatories for certain actions or under certain conditions.

b) Implementation

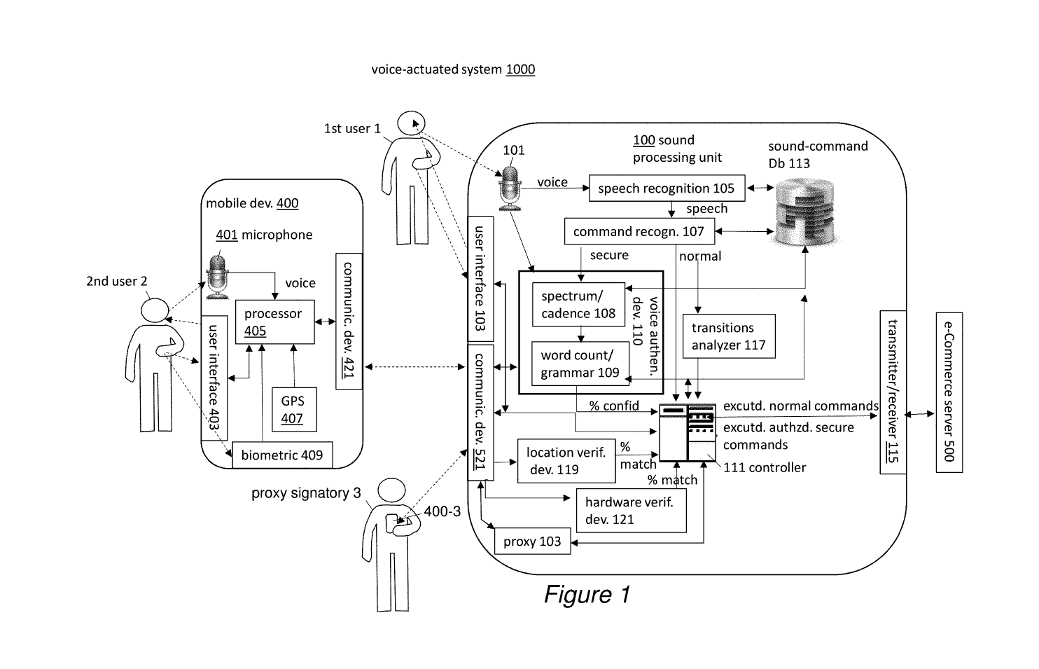

FIG. 1 illustrates a block diagram of a voice-actuated system allowing for voice authentication of secure commands according to one embodiment of the current invention.

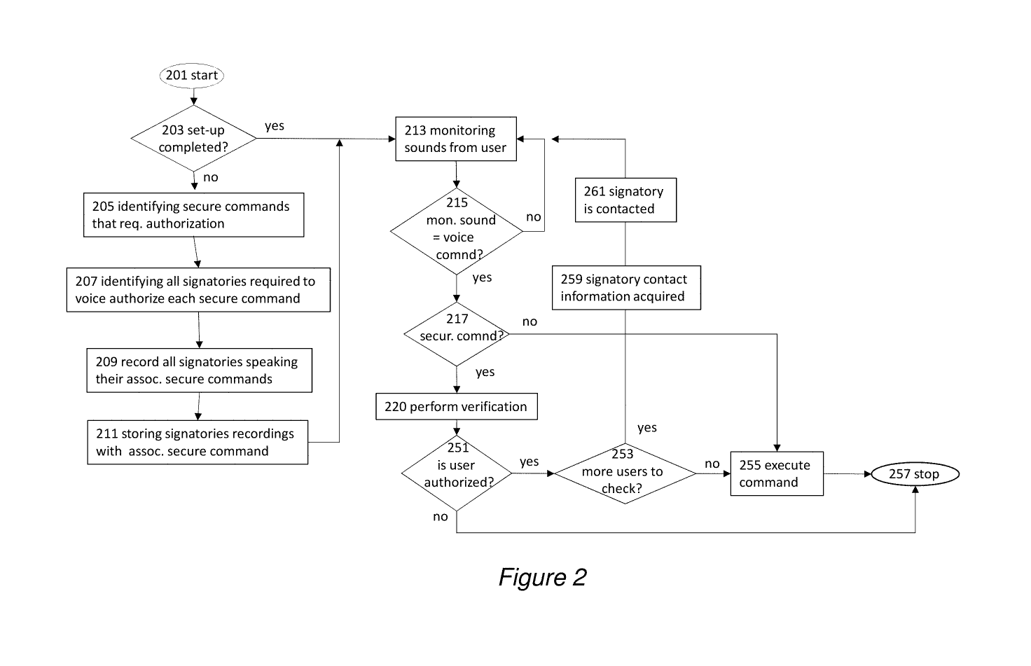

FIG. 2 is a flowchart illustrating the functioning of a voice-actuated system according to one embodiment of the current invention.

A voice actuated system 2000 is shown and described in connection with FIGS. 1 and 2. The functioning of this system begins at step 201.

In step 203, a local user 1 interacts through user interface 103 with controller 111 To determine if an initial set-up has been completed in step 203. If so, “yes”, processing continues in step 213.

If set-up has not yet been completed, “no”, processing continues at step 205. The identity of the user 1 is verified and authenticated using some verifiable form of identification. The user 1 may be identified with the use of a biometric device inside user interface 103, by answering questions, or providing information that should only be known to the user 1. This may be implemented by user 1 providing information for user interface 103 to controller 111.

Once the user has been properly authenticated, in step 207, controller 111 provides words or phrases (secure commands or secure voice commands) to user 1 through user interface 103 to speak into microphone 101.

User 1 reads the words or phrases into microphone 101 which are monitored by speech recognition device 105 as voice samples.

In step 209, speech recognition device 105 records the voice samples pertaining to the words or phrases being read by user 1 (associated secure commands), along with the associated command in a sound command database 113.

In step 211, spectrum/cadence analyzer 108 performs a spectral frequency analysis of the monitored sounds for each command and stores each frequency analysis in sound command database 113 along with its associated secure command.

This process is repeated for all secure commands being those that are only allowed to be executed if they are from this specific speaker.

Secure commands are not to be executed even if the user 1 gives the proper command wording but is not identified as an authorized user.

After completing step 211, the set-up phase has been completed, and processing continues at step 213. Beginning at step 213 through the rest of the flowchart, FIG. 2 shows the steps of the operation phase of the process of the current invention after the set-up phase has been completed.

During the operation phase, in step 213, sounds from user 1 are received by microphone 101 and are monitored by speech recognition device 105 in step 213. Speech recognition device 105 can act as a conventional speech recognition device and recognize sounds as spoken speech.

Speech recognition device 105 also has the ability to add secure commands to its library that were entered into sound command database 113 during the set-up phase, and recognize these commands.

In step 215, speech recognition device 105 identifies sounds that appear to be speech. Since speech recognition device 105 must monitor and match up the monitored sounds to speech or commands “on-the-fly”, it can use an abbreviated portion of the monitored sounds to analyze to identify speech. It may use a narrower spectrum to analyze or coarser sampling.

Once the speech is identified, in step 215 it is determined if it pertains to a voice command. This is done by command recognition device 107. Command recognition device 107 can compare the speech received to commands stored in the sound command database 113. Once it is found, it can also identify if the command is a normal or secure command as required by step 217.

If it is not a secure command, (“no”), then the command is converted to an equivalent electronic signal for execution and executed in step 255.

In step 217, if it is determined that it is a secure command, “yes”, then the monitored sounds are verified in step 220.

In step 251, if the user has not been authorized in step 220 (“no”), then the secure command is not executed and processing stops at step 257.

In step 251, if the user has been authorized in step 220 (“yes”), then processing continues at step 253.

In step 253, it is determined if more signatories are required to authorize the transaction. If not (“no”), then the secure command is executed in step 255.

If more signatories are required (“yes”), then processing continues at step 259.

In step 259, the contact information for a required signatory who has not yet authorized the transaction is acquired.

In step 261, this signatory is contacted and processing continues at step 213.

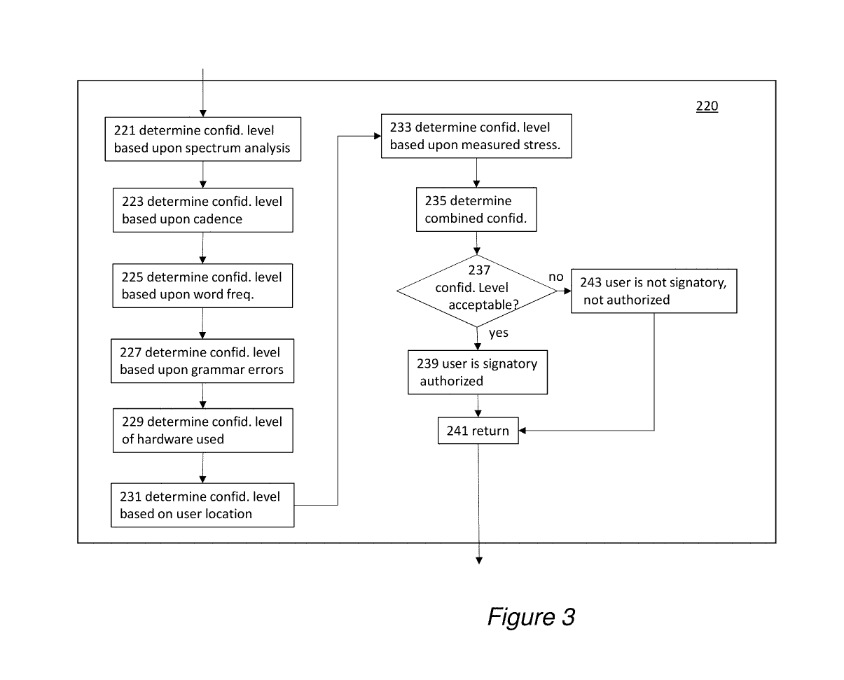

FIG. 3 is a more detailed flowchart of the process performed in step 220 of FIG. 2.

In step 221, the voice sample is provided to the spectrum/cadence analyzer 108 for spectral analysis. The pre-stored spectral analysis of the authorized speaker speaking the secure commands is used from the sound command database 113 and compared to the spectral analysis of the monitored sounds to determine how closely they match. A confidence level is determined based upon how closely they match.

In step 223, the voice sample provided to the spectrum/cadence analyzer 108 is analyzed for cadence. The pre-stored spectral analysis of the authorized speaker speaking the secure commands is used from the sound command database 113 and compared to the cadence of the monitored sounds to determine how closely they match. A confidence level is determined based upon how closely they match.

In step 225, the voice sample is provided to the word count/grammar device 109 and is analyzed for the frequency of each word used. Word count is an average usage of unique words used by the user. This is like a verbal ‘fingerprint’.

Repeated common grammar mistakes made by a user also can help to uniquely identify a user 1.

The pre-stored word count and grammar of the user 1 is acquired from the sound command database 113 and compared to that of the monitored sounds to determine how closely they match based on word frequency and/or repeated grammar errors. A confidence level is determined based upon how closely these match.

In step 229, the hardware identification of the user's mobile device is acquired. This may be a MAC address, IP address, device manufacturer, model, and other hardware information. These are compared to hardware information of other mobile devices used by the user 1. A level of confidence is created based upon how much of this information matches past hardware information. Alternatively, this level of confidence may be weighted upon how long ago the user used the hardware that matches the current hardware.

In step 231, the user's location is compared to past locations of the same user. A confidence level is created which is based upon how far the current user location is as compared to the areas the user 1 frequents. Alternatively, it may be based upon how many time the user 1 has been close to the current location in the past.

In step 233, the voice sample is provided to the spectrum/cadence analyzer 108 for spectral analysis. In this spectral analysis, an average user pitch is determined. It is also analyzed for micro variations, or wavering of the voice. This spectral analysis is compared to that pre-stored in the sound command database 113 to determine how closely they match. A confidence level is determined based upon how closely they match indicating how calm a user 1 is.

In step 235, the confidence levels are combined. In one embodiment, all the confidence levels are combined. In an alternative embodiment, less than all confidence levels are determined and/or combined. In still another embodiment, some, or all the confidence levels may be calculated, weighted, then the weighted confidence level combined. Other variations of how the confidence levels are combined are also possible and within the spirit of this invention.

In step 237, it is determined if the combined confidence level is above a pre-determined threshold (“yes”) and if so, processing continues at step 239.

In step 239, the user 1 is identified as the signatory and the secure command is authorized by this signatory.

If the combined confidence level is not above a pre-determined threshold (“no”), then the user is deemed not to be a signatory and the secure command is not authorized.

In step 241, processing returns to step 251 of FIG. 2,

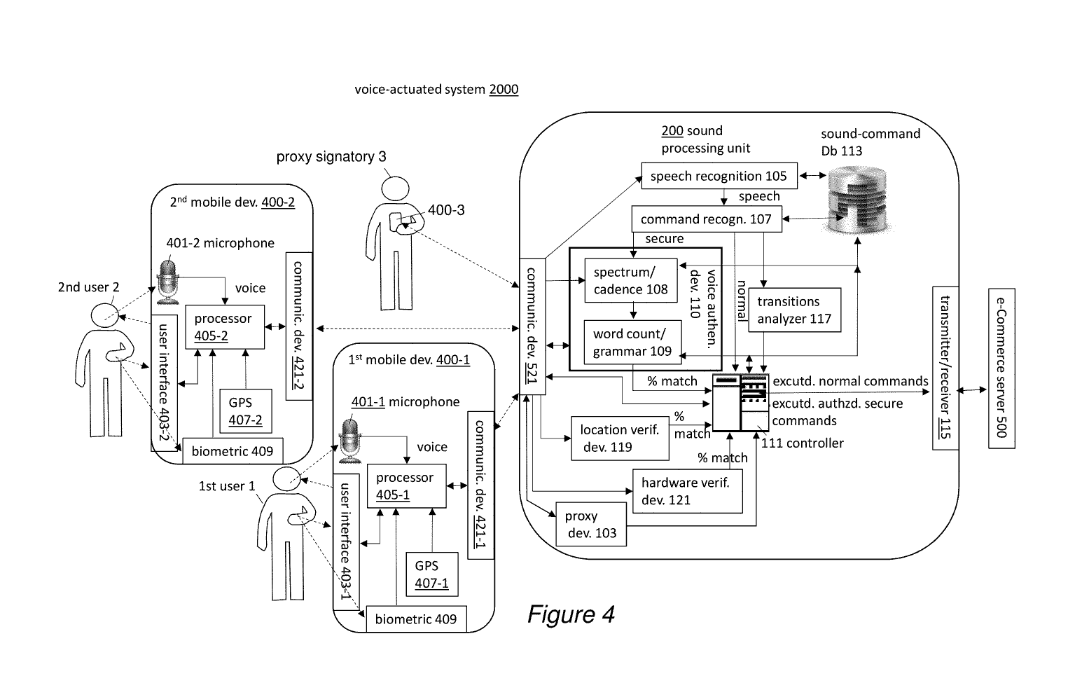

FIG. 4 illustrates a block diagram of a voice-actuated system allowing for voice authentication of secure commands according to another embodiment of the current invention.

The elements of FIG. 4 function in the same manner as the elements of FIG. 1 having the same numbers described above.

The architecture of the voice-actuated system 2000 of FIG. 4 uses a personal computing device 400-1, such as a smart phone to provide the user interface 403-1 and microphone 401-1. Information is communicated in both directions between the personal computing device 400-1 and the sound processing unit 200 through communication devices 421-1 and 521 respectively. Sound processing unit 200 can be an intermediate server, or can be located remotely, but can communicate with personal computing device 400-1 and e-commerce server 500.

Even though the above description was written generally to refer to secure commands, one specific secure command which this system will apply is that of voice authorization of payment to e-commerce server 500. In this case, the user 1 is the one initiating the purchase. The spectral analysis and cadence analysis will properly identify user 1. The spectrum/cadence analyzer 108 will determine if the user 1 is under extreme stress and prevent any voice payments until the speaker is no longer stressed. (One assumption is that a speaker that is stressed may be under duress to make the purchase, and is not acting under his/her own will.)

### Proxy Signatory

In some cases, the signatory of an account will not be available to authorize a transaction. This may be due to a planned or unplanned event. For example, a teenaged child is authorized to make on-line purchases on the father's account, if the father authorizes the transaction as a signatory. The child is going camping with the neighbors and would like to make purchases on the account. In this case, the father (user 2) can designate his adult neighbor (user 3) as a proxy signatory.

When this occurs, it is the equivalent of adding a signatory. Set-up of steps 201 through 211 of the process of FIG. 2 must be completed to get a voice sample of the proxy signatory, neighbor (user 3). Also, the contact information for the neighbor's mobile device 400-3 must be provided to the system for the proxy signatory (user 3) so that the system knows where to call for authorization. Once the child makes an on-line purchase on this account, the system replaces the original signatory, the father (user 2), with the proxy signatory, the neighbor (user 3).

When setting up the proxy signatory (user 3), the signatory (user 2) can set a time limit for the signatory proxy to have power, a maximum dollar amount for any transaction, or cumulative transactions, or other restrictions.

The signatory (user 2) will be able to retract the proxy power at any time for any reason.

For example, when the system determines that the user 1 is upset, it may provide buttons on a screen allowing the speaker/user to select more/less detailed instructions, increase/decrease the speed of responses, use more/less default values instead of requiring user 1 input.

### Secure Set-Up

In an alternative embodiment of the set-up phase, the user 1 reads a password or pass phrase into the system which is recorded, associated with a secure command and stored. When in the operation mode, the user 1 speaks a password/phrase into the system. This system decodes the password/pass phrase to determine if it is the correct password/phrase. It also analyzes the voice spectrum and compares it to the authorized speaker's voice saying the password/phrase. If there is a match within a certainty range, the secure command associated with the password/passphrase is executed. Therefore, this requires the user 1 to know the correct password/passphrase but also to have the correct user.

### System-Generated Phrases

In an alternative, more secure embodiment, during the set-up phase, the system may generate words or paragraphs of text that are displayed on the user interface. The user 1 is then prompted to read the words/text into the system which are recorded. The sounds recorded are associated with the words displayed and stored.

Later in an operation mode, random phrases are provided to the user 1 to repeat. The system searches through the database looking for matching recorded sounds to authorize the user 1. This is intended to prevent one from trying to use a recording of the user to trick the system.

Although a few examples have been shown and described, it will be appreciated by those skilled in the art that various changes and modifications might be made without departing from the scope of the invention, as defined in the appended claims.

What is claimed is:

1. A voice actuated system adapted to provide secure authorization of secure commands comprising:
a mobile device adapted to communicate a voice input from a remote user;
a sound processing unit comprising:
a communication device adapted to communicate with the mobile device and receive the voice input from the second user,
a microphone adapted to receive a voice input from a local user;
a sound command database having prestored voice input to word data, having a prestored indication of commands and which commands are secure commands, having prestored reference samples of secure commands from a plurality of authorized users;
a speech recognition device coupled to the communication device, the microphone and the sound command database adapted to receive the voice input from the mobile device, the voice input from the microphone and match each of them to prestored voice input in the sound command database to identify corresponding words;
a command recognition device coupled to the speech recognition device and the sound command database adapted to receive the corresponding words and identify corresponding commands in the sound command database, also adapted to identify if the commands are secure commands;
a voice authentication device having a spectrum/cadence analyzer coupled to the command recognition device and the communication device, adapted to receive the voice input and compare it to the prestored reference samples of secure commands from a plurality of authorized users in the sound command database to determine a confidence level of how closely they match;
a location verification device to receive a location of the mobile device and determine a confidence level of how close this location is to locations where the mobile device has previously been located;
a hardware verification device adapted to receive a hardware identification of the mobile device and determine a confidence level of how close it matches the hardware identification of mobile devices previously used by the remote user;
a controller coupled to the communication device and to the voice authentication device, the location verification device, the hardware verification device, adapted to:
combine the determinations of the voice authentication device, the location verification device, the hardware verification device;
determine if the combination exceeds a predetermined threshold to identify the remote user, and;
repeating the above steps for the local user, before allowing execution of a secure command.

2. The voice actuated system of claim 1, where the spectrum/cadence device is adapted to determine a baseline cadence and compare it to a prestored baseline cadence stored in the sound command database and determine voice stress of at least one user based upon the comparison.

3. The voice actuated system of claim 1, wherein controller obtains contact information for the remote user from the sound command database and sends a request for voice authorization to the remote user along with a phrase to speak.

4. The voice actuated system of claim 1, further comprising a proxy device adapted to:
receiving a request to replace a signatory with a proxy signatory;
receiving contact information for a mobile device of the proxy signatory;
contacting the mobile device;
acquiring and storing voice samples from the proxy signatory;
notifying the communication device and controller to interact with the mobile device of the proxy signatory in place of the mobile device of the remote user.

5. The voice actuated system of claim 1, wherein controller ‘times out’ and will no longer accept voice input for the secure command if all authorizations are not received in a specified time period.

6. The voice actuated system of claim 1, further comprising:
a transitions analyzer adapted to compare reference samples in the sound command database to voice input to determine slurring of speech.

7. A method of having a first user and a second user authorize execution of a secure command, comprising the steps of:
receiving a first voice input from a first mobile device used by the first user;
identifying the first user at a sound processing unit by finding a match for the first voice input in a sound command database;
finding accounts associated with the first user;
interacting with the first user to select one of the accounts;
finding contact information for a second mobile device of a second user required to authorize secure commands on the selected account;
sending a request for voice authorization to the second mobile device;
receiving second voice input from the second mobile device;
determining a level of confidence of how closely the voice input from the second mobile device matches prestored voice for the second user;
determining a level of confidence of how close the current location of the second mobile device is to previous stored locations of the second user;
determining a level of confidence of how closely the hardware identification of the second mobile device matches a previously-stored hardware identification of a mobile device used by the second user,
combining the determined confidence levels of the voice authentication device, the location verification device, the hardware verification device;
determining if the combination exceeds a predetermined threshold to identify the first user, and;
repeating the above steps for at least one additional user before allowing execution of a secure command.

8. The method of claim 7 wherein the secure command is a command to make a financial payment on-line.

9. The method of claim 7 further comprising the step of:
using a transitions analyzer to determine if at least one of the voice inputs exhibits slurring, and preventing execution of the secure command if the determined slurring level is above a predetermined threshold.

10. A voice actuated system adapted to provide secure authorization of secure commands comprising:
a first mobile device adapted to communicate a first voice input from a first user;
a second mobile device adapted to communicate a second voice input from a second user;
a sound processing unit comprising:
a communication device adapted to communicate with the mobile devices and receive the first voice input from first user and second voice input from user,
a sound command database having prestored voice input to word data, having a prestored indication of commands and which commands are secure commands, having prestored reference samples of secure commands from a plurality of authorized users;
a speech recognition device coupled to the communication device and the sound command database adapted to receive the first voice input and second voice input and match them to voice input in the sound command database and identify corresponding words;
a command recognition device coupled to the speech recognition device and the sound command database adapted to receive words and identify corresponding commands in the sound command database, also adapted to identify if the commands are secure commands;
a voice authentication device having a spectrum/cadence device coupled to the command recognition device and the communication device, adapted to receive the first voice input and the second voice input and compare them to the prestored reference samples of secure commands from a plurality of authorized users in the sound command database to determine a confidence level of how closely they match;
a location verification device to receive a location of the mobile device of the first user and determine a confidence level of how close this location is to locations where the mobile device has previously been located;
a hardware verification device adapted to receive a hardware identification of the mobile device of the first user and determine a confidence level of how closely it matches hardware identification of mobile devices previously used by the first user;
a controller coupled to the communication device and to the voice authentication device, the location verification device, the hardware verification device, adapted to:
combine the determinations of the voice authentication device, the location verification device, the hardware verification device;
determine if the combination exceeds a predetermined threshold to identify the first user, and;
repeating the above steps for at least one additional user, before allowing execution of a secure command.

11. The voice actuated system of claim 10, wherein controller obtains contact information for the mobile device of the second user from the sound command database and sends a request for second voice input to the mobile device.

12. The voice actuated system of claim 10, further comprising a proxy device adapted to:
receiving a request to replace a signatory with a proxy signatory;
receiving contact information for a mobile device of the proxy signatory;
contacting the mobile device;
acquiring and storing voice samples from the proxy signatory;
notifying the communication device and controller to interact with the mobile device of the proxy signatory in place of the mobile device of the second user.

13. The voice actuated system of claim 10, wherein controller ‘times out’ and will no longer accept voice input for the secure command if the second voice input is not received in a specified time period.

14. The voice actuated system of claim 11, wherein the at least two users are joint signatories on a financial account.

15. The voice actuated system of claim 10, wherein the first mobile device provides the voice input to the sound processing unit, and the sound processing unit is further adapted to:
determine contact information for a second mobile device used by a second user;
send a request for a voice authorization from the second user listed on an account to the second mobile device, for secure commands;
send information relating to an entity that is to receive the secure command to the second mobile device;
receive second voice input from the second mobile device authorizing the secure command;
execute the secure command after the identity of the first user and second user have been identified as all the required signatories on an account.

16. The voice actuated system of claim 10, wherein the first mobile device further comprises:
a location determination device (GPS) adapted to:
determine a location of the mobile device, and
send the location of mobile device with the first voice input to a second mobile device;
wherein both the first voice input and the location can be used by second user to determine if the secure command should be authorized.

17. The voice actuated system of claim 16 wherein secure commands will not be authorized if the location relates to a prestored proscribed location.

18. The voice actuated system of claim 17 wherein proscribed location relates to one of the group of a liquor store, parking lot and parking garage.

19. The voice actuated system of claim 10 wherein the second user is a joint signatory on a financial account with the first user.

20. The voice actuated system of claim 10 wherein the first user and the second user are a married couple.
